(19) United States
(12) Patent Application Publication
(10) Pub. No.: US 2010/0168335 A1
(43) Pub. Date: Jul. 1, 2010

(54) METHOD FOR PRODUCING POLYMER MIXTURES

(75) Inventors: Rolf Muller, Zurich (CH); Federico Innerebner, Zurich (CH)

Correspondence Address: K&L Gates LLP, P.O. Box 1135, CHICAGO, IL, 60690, US

(73) Assignee: INNOGEL AG, Hunenberg (CH)

(21) Appl. No.: 12/532,591

(22) PCT Filed: Mar. 20, 2008
(86) PCT No.: PCT/CH08/00124

§ 371 Date: Feb. 8, 2010

(30) Foreign Application Priority Data
Mar. 23, 2007 (DE) 10 2007 014 621.5

(51) Int. Cl. C08L 53/00

(52) U.S. Cl. 525/89

(57) ABSTRACT

The invention relates to a process for the advantageous production of polymer mixtures with specific molecular weight distributions, having a quantitatively low short-chained proportion and substantially improved processing characteristics, the working up steps during or after the synthesis of the main portion of the polymer mixture being used to produce the mixture.

### PRIOR ART

The favourable mechanical properties of polymers result from the fact that polymers are very long molecules. Various properties such as strength, toughness and abrasion resistance typically increase with the length of the polymers and therefore with the molecular weight thereof. However, the viscosity of polymer melts increases considerably with the molecular weight thereof in such a way that processing the high-viscosity polymer melts becomes increasingly difficult. For this reason, wide, bimodal or multimodal molecular weight distributions have been developed by applying suitable synthesis conditions, combining the advantages of high and low molecular weight polymers. Syntheses which take place in one, two or a plurality of reactors in turn have been developed, as is disclosed in US 2006/0068085 A1, US 2005/0054799 A1, US 2006/0167181 A1, US 2007/0123414 A1, WO 2006/052232. A wide molecular weight distribution of PE typically starts at approximately 10,000 and ends somewhat below 10,000,000, the weight average being in the range of 100,000 to 1,000,000. The expense is in all cases greater than for simpler molecular weight distributions, and therefore polymers with optimised molecular weight distributions entail additional costs. The difficulties in the production of wide molecular weight distributions increase with the width thereof.

On the other hand, a plurality of substances, in particular additives, with which the flow characteristics and thus the processing characteristics of polymers can be improved are commercially available. However, as well as the additional costs, these additives, such as fatty acid derivatives, often also have a negative effect on the end product and the plastics materials fabricator must evaluate a number of additives of this type for their suitability, leading to greater expense.

The present invention discloses technology which substantially improves the flow properties of polymer melts without having a detrimental effect on the end product and allows complicated and expensive syntheses to be avoided.

For this purpose, during the synthesis of a polymer P1 or in a subsequent working up step, an independently produced short-chain polymer P2 is mixed in, in a proportion typically of up to a few percent, it being possible to employ various processes for this purpose. What is important is that the fully worked up polymer P1 already contains the short-chain polymer P2. A synthesised polymer is often homogenised in the melt phase in the course of the working up, and this processing step can thus be used to mix in a short-chain polymer and homogenise it with the long-chain polymer. The resulting granulate then contains the short-chain polymer and has considerably improved flow properties, and this means that the processing of end products, for example by extrusion or injection moulding, is facilitated, for example in that it is possible to accelerate and optimise the corresponding process.

Because the short-chain polymers according to the invention are of a similar price to analogous long-chain polymers produced in a simple manner and an additional processing step is not necessarily required to combine the two polymers, it is thus possible to obtain polymers with improved flow properties at a favourable price/yield ratio.

The improvements in the flow properties are thus considerably more pronounced than in wide molecular weight distributions, because it is possible to use short-chain polymers with a very low molecular weight, for example in the region of 1,000 g/mol. Comparatively short polymers of this type have viscosities which are typically lower by a factor of 10,000 to 100,000 than the viscosities either of conventional polymers or of wide-distribution-molecular-weight polymers. They thus act as excellent internal lubricants even in small proportions. For example, a proportion of approximately 3% of a short-chain polymer of this type is sufficient to reduce the cycle time of the equivalent long-chain polymer by approximately 30%. Because the processing of plastics materials to form the end product is a significant cost factor, by virtue the low prices of said materials, an improvement of 30% in the processing output would provide a major advantage without any investments being required for this purpose.

Because of the small proportion of the short-chain polymer, its effect on the properties of the processed end product is zero to a first approximation. The typical drawbacks of conventional flow promoters are not observed. To a second approximation, the final properties are in fact influenced, but generally positively. This is surprising because short-chain polymers would actually be expected to worsen the properties, since favourable properties normally result from long-chain polymers.

The combination of improved flow properties with unchanged or even improved properties of the end product is achieved in the case where the short-chain polymer P2 is compatible with the long-chain polymer P1. In this case, compatibility means that the two polymers are soluble in one another and in particular can crystallise together. The polymer P2 is then incorporated into the partially crystalline network formed by the polymer P1. The number of connections between crystallites is reduced somewhat if a proportion of long-chain polymer is replaced with a short-chain polymer, and this theoretically somewhat reduces the toughness, but the modulus of elasticity and the yield strength are actually increased because of the increased crystalline content. However, in practice the expected reduction in toughness is either low or non-existent, because the improved flow properties and the lower processing temperatures, which they make possible, cause the frozen-in stresses in the end product to be reduced.

The short-chain polymers which are advantageous in this way need not necessarily already have been mixed into the polymer products by the polymer manufacturer; this could also be done by the fabricators of the polymer products. However, there are logistical and qualitative advantages if the mixing process is already performed centrally by the polymer manufacturer. Transport and intermediate trading are rendered unnecessary and it can be guaranteed that the polymer mixture P1 and P2 is homogeneous, whereas otherwise homogeneous mixing of the two polymers is not always possible in the devices used by the fabricators or it may only be possible for approximately 1% by weight of polymer P1 to be mixed sufficiently homogeneously into a polymer P2. The greater the amount of the short-chain polymer to be mixed in, the more difficult it is for fabricators' devices to homogenise the two polymers with such extremely different viscosities, and this means that the most advantageous range cannot be exploited. Moreover, it is easier for the fabricators if they receive a more free-flowing product, for which the processing is well documented and standardised, from the polymer producer than if they have to produce it from the two components in their own processing processes.

If the polymer mixture P1 and P2 is manufactured centrally and directly by the polymer manufacturer, this further has the advantage that the improved flowability can be exploited there immediately to optimise the working up of synthesised polymer. The working up, in particular the homogenisation, of the polymer is facilitated by a proportion of short-chain polymer. The development of working-up devices, which are generally extruders, tends towards ever-increasing throughput rates for cost optimisation purposes, currently approximately 70 to/h for polyolefins. Limiting factors here are the high temperatures, temperature peaks and pressures which result from the high-viscosity material in the case of high energy input and can damage the polymer and cause technical problems, for example in the screen changer. With improved flowability for the polymer, existing limits can be exceeded and thus costs can also be saved in this respect. Increases of even a few percent in the throughput rates are of great significance as regards the dimensions, especially if the improved quality of the product obtained leads to further additional value.

### DETAILED DESCRIPTION OF THE INVENTION

To achieve the described advantages, the polymers P1 used, the short-chain polymers P2 and the combination of the two components and the processing thereof must meet particular conditions, which will be described in the following. Both logistical and material-related aspects for application are involved.

Polymer P2 is mixed into polymer P1 during the synthesis of polymer P1 or at a time during the subsequent processing, in particular during the homogenisation of polymer P1, such that the complete manufactured product already contains the polymer P2. When the product leaves the manufacturer, it contains the polymer P2 and is thus shaped into the end product by the fabricator, who receives the polymer P1+P2.

Long-Chain Polymer P1

In principle, the polymer P1 may be any polymer. It could for example be selected from the following group: polyolefins, in particular polyolefins of monomers with 2 to 10 C atoms, PE, in particular UHMWPE, HMWPE, HDPE, LDPE, LLDPE, VLDPE, PP, in particular isotactic PP, syndiotactic PP, atactic PP, PE-PP copolymers, PE copolymers, PP-PE copolymers, PP copolymers, PVA, PVC, PC, PA, PU, ABS, PS, SAN, POM, CA, PMMA, PPE, PPS, PSO, PTFE, PET, PBT. Based on the size of the market, the polyolefins, in particular PE and PP, are the most significant group of substances. P1 may also be a mixture of different types of plastics materials from the same class, for example different PE types or different PP types. Furthermore, the copolymers derived from the aforementioned classes and types of plastics materials (with a proportion of a second type of monomer) and terpolymers (with a proportion of a second and third type of monomer) and higher copolymers (with more than 3 monomer types) are possible, it being possible for the additional monomers to be arranged randomly and/or in block form.

In a preferred embodiment, the proportion of the additional monomers in copolymers is <40, preferably <20, more preferably <10, most preferably <5% by weight, if a polymer which is compatible with the predominant monomers of P1, and which has a copolymer proportion of <20, preferably <15, more preferably <10, most preferably <5% by weight is used for the polymer P2, the monomers of the copolymer portion of polymer P1 and P2 not having to be identical but preferably being identical.

In a preferred embodiment, if the additional monomers are also olefinic, for example PP-PE and PE-PP copolymers, then the proportion of these additional monomers in polyolefins is <50, preferably <30, more preferably <20, most preferably <10% by weight, if a polymer which is compatible with the predominant monomers of P1, and which has a copolymer proportion of <20, preferably <15, more preferably <10, most preferably <5% by weight is used for the polymer P2, the monomers of the copolymer portion of polymer P1 and P2 not having to be identical but preferably being identical.

In a preferred embodiment, the polymer P1 is at least partially crystalline. The crystalline content is >3, preferably >5, more preferably >7, most preferably >10% by weight, the crystalline content being determined by density measurement in accordance with the prior art.

In a preferred embodiment, the MFI of polymer P1 as measured at standard temperature in g/10 min at 2.16 kg is <200, preferably <50, more preferably <35, most preferably <20, because as the MFI of P1 increases, the relative improvement in the flow properties of the mixture M which can be achieved by adding polymer P2 decreases, whilst the costs remain approximately the same. In a preferred embodiment, the lower limit for the MFI of P1 is >0.005, preferably >0.01, more preferably >0.05, most preferably >0.1, because as the MFI of P1 decreases, the homogenisation of P2 becomes more difficult. For PE and PP, the standard temperature is 190° C. For other polymers, the temperature is approximately 20-40° C. above the typical melting point of the polymer.

The weight-average molecular weight Mw of P1 is >20,000 g/mol. In a preferred embodiment, this molecular weight is >30,000, preferably >50,000, more preferably >70,000, most preferably >90,000. The upper limit for the molecular weight Mw for polymer P1 is determined by the plasticisability and is <6,000,000. In a preferred embodiment, this limit is <5,000,000, more preferably <4,000,000, most preferably <3,000,000.

The number-average molecular weight Mn of P1 is >20,000 g/mol. In a preferred embodiment, this molecular weight is >30,000, preferably >40,000, more preferably >50,000, most preferably >70,000.

If the polymer P1 has a bimodal or multimodal or a wide molecular weight distribution then, in a preferred embodiment, the proportion by weight of polymer P1 with a molecular weight of <10,000 is less than 40%, preferably less than 30%, more preferably less than 20%, most preferably less than 10%.

Short-Chain Polymer P2

The viscosity of the short-chain polymer P2 is <10,000 mPas. In a preferred embodiment, this viscosity is <5,000, preferably <3,000, preferably <1,000, preferably <500, preferably <200, more preferably <160, most preferably <100. The lower this viscosity, the greater the effect in terms of the improvement in the flow properties. Therefore, the viscosity of the polymer P2 may also be substantially less than 100 mPas, for example 50 or 10 mPas. The lower limit of the viscosity of P2, if P1 is a partially crystalline polymer and P1 and P2 can crystallise together, in mPas is >0.1, preferably >0.5, more preferably >1, most preferably >2. The reason for the lower limit is that if P2 has too low a viscosity, i.e. too low a molecular weight, then the final properties of the end product can be adversely affected.

The viscosity of P2 is measured at a temperature of approximately 10° C. above the melting point of the associated long-chain polymer P1. This temperature is 140-150° C. for short-chain PE and 170-180° C. for short-chain PP.

If P1 is not partially crystalline and no crystallisation of P1 and P2 together is possible, then the lower limit for the viscosity of P2 in mPas is >1, preferably >3, more preferably >6, most preferably >10, because the polymers P2 become heavier and migrate less as the viscosity increases.

In a preferred embodiment, the polymer P2 is predominantly linear, preferably completely linear, and comprises at least one block of >10, preferably >14, more preferably >17, most preferably >20 identical monomer units M2. In most cases, P2 consists exclusively of monomer units M2. The definition of monomer units is generally clear. For PE, a unit with 2 C atoms is understood to be a monomer unit, both for short-chain and for long-chain PE.

In linear polymers P2, the viscosity increases with Mw, the weight-average molecular weight, as expected. However, the viscosity of branched, in particular highly branched polymers is of a considerably lower value than for linear polymers of the same Mw. Thus, for example, the hyperbranched polyethylene VY BAR 825 of Baker Petrolight with Mw=4760 has a viscosity of approximately 18 mPas at 140° C., whilst a linear polyethylene with the same Mw has a viscosity of approximately 300 mPas.

Therefore, in another preferred embodiment the polymer P2 has a branched, in particular hyperbranched structure, most preferably a spheroid shape. With comparatively heavy polymers P2, which do not migrate or only migrate a little and can have a positive effect on the toughness, it is then possible to achieve a low melt viscosity.

In a preferred embodiment, the molecular weight distribution of polymer P2 has a polydispersity PD=Mw/Mn of <10, preferably <5, more preferably <3, most preferably <2. As the polydispersity decreases, better results are achieved in terms of process acceleration and the final properties. Therefore, monodisperse or substantially monodisperse distributions with PD close to 1 are particularly advantageous. Very good results were obtained with short-chain PE with a PD of approximately 1.1.

In a preferred embodiment, the vapour pressure of polymer P2 at 250° C. is <100, preferably <30, preferably <10, preferably <1, more preferably <0.1, most preferably <0.01 mbar. This ensures that when working up and processing melts containing polymer P2, a vacuum can be applied without the polymer P2 being drawn off from the melt.

The short-chain polymer P2 can in principle be any polymer and is for example selected from the following group: short-chain PE, PVA, PVC, PC, PA, PU, ABS, PS, SAN, POM, CA, PMMA, PPE, PPS, PSO, PTFE, PET, PBT. These are produced for example from the corresponding long-chain polymers by degradation (for example thermally or with a metal catalyst), or synthesised in short-chain form at the outset, various polymerisation systems being available for this in the prior art. Short-chain polymers P2 may also be mixtures of various types of P2 from the same class of plastics materials, for example different types of PE waxes.

There is a wide selection of short-chain PE on the market, and they may for example be selected from the following group: n-alkanes CₙH₂ₙ₊₂; isoalkanes Cₙ; cyclic alkanes CₙH₂ₙ; polyethylene waxes, paraffins and paraffin waxes of mineral origin such as macrocrystalline, intermediate or microcrystalline paraffins, brittle, ductile, resilient or plastic microcrystalline paraffins; paraffins and paraffin waxes of synthetic origin. PE waxes, Fischer-Tropsch waxes and hyperbranched polyolefins are preferred.

Examples of suitable PE waxes are the Polywax products of Baker Petrolight; see Table 1.

TABLE 1

| | Viscosity at | | | Vapour pressure | |
|---|---|---|---|---|---|
| | 140° C. | Mw | | at 250° C. | Density |
| P1 | mPas | g/mol | Mw/Mn | mBar | g/cm³ |
| PW 500 | 4 | 540 | 1.08 | Approx. 3 | 0.93 |
| PW 1000 | 15 | 1080 | 1.08 | Approx. 0.01 | 0.96 |
| PW 3000 | 160 | 3240 | 1.08 | <<0.01 | 0.98 |

Preferred PE and PP waxes are obtained by synthesis by polymerisation, for example by Ziegler Natta polymerisation, Philipps polymerisation (chromium oxide catalysts), radical polymerisation or metallozene polymerisation, the metallozene polymerisation being particularly preferred.

### Mixtures of the Polymers P1 and P2

To enable the advantageous effects of the short-chain polymer on the processing properties and the final properties, polymers P1 and P2 must be compatible. In this case, compatibility means that P1 has at least one block with >10 monomer units M1 and P2 has at least one block with >10 monomer units M2 where M1 is identical to M2. If P1 is a partially crystalline polymer, compatibility between P1 and P2 means that the two polymers can crystallise together. If the polymers P2 are integrated into crystallites with P1, they are prevented from migrating and can make a useful contribution to the mechanical properties.

If P2 is in the form of highly branched and hyperbranched or spheroid short-chain polymers, then crystallisation of P1 and P2 together is not actually necessary for compatibility, and the migration is prevented by a higher molecular weight of the spheroid polymers. If polymer P1 is completely or mainly amorphous, then a P2 with a higher molecular weight may optionally also be used in order to prevent the migration. The compatibility condition still allows for good miscibility of P1 and P2 in this case.

The proportion of polymer P2, based on polymer P2 and polymer P1, is generally >0.1, preferably >0.2, more preferably >0.3, most preferably >0.4% by weight and <25, preferably <19, more preferably <15, most preferably <11% by weight.

In a preferred embodiment, the upper limit for this proportion is <H, preferably <G, more preferably <F, most preferably <E.

In a preferred embodiment, the lower limit for this proportion is >A, preferably >B, more preferably >C, most preferably >D.

The values of A to H depend on the viscosity of the polymer P2 and are given for a wide range of viscosities in Table 2. The values of the limits for viscosities not given are obtained by linear interpolation or extrapolation. The limits given for each viscosity of polymer P2 reflect the situation whereby as the viscosity of P2 decreases, the efficiency thereof in terms of improving the flow properties increases, i.e. less of it is required, whilst with higher proportions the toughness of P1+P2 can be adversely affected.

TABLE 2

| Viscosity | | | | | | | | |
|---|---|---|---|---|---|---|---|---|
| of P2 | | | | | | | | |
| [mPas] | A | B | C | D | E | F | G | H |
| 0.5 | 0.1 | 0.2 | 0.4 | 0.7 | 3 | 5 | 7 | 10 |
| 2.5 | 0.2 | 0.3 | 0.6 | 0.9 | 5 | 6 | 9 | 12 |
| 7.5 | 0.3 | 0.4 | 0.7 | 1.0 | 6 | 7 | 10 | 13 |
| 15 | 0.3 | 0.5 | 0.8 | 1.1 | 7 | 9 | 11 | 14 |
| 35 | 0.4 | 0.6 | 0.9 | 1.1 | 7 | 9 | 12 | 15 |
| 75 | 0.4 | 0.6 | 0.9 | 1.2 | 8 | 10 | 13 | 16 |
| 150 | 0.5 | 0.7 | 1.0 | 1.3 | 8 | 10 | 14 | 17 |
| 350 | 0.6 | 0.8 | 1.2 | 1.4 | 8 | 11 | 14 | 18 |
| 750 | 0.7 | 1.0 | 1.2 | 1.5 | 9 | 12 | 15 | 19 |
| 2000 | 0.8 | 1.2 | 1.6 | 2.0 | 9 | 12 | 16 | 21 |
| 4000 | 0.9 | 1.3 | 1.7 | 2.5 | 9 | 13 | 18 | 23 |
| 7500 | 1.0 | 1.5 | 2.0 | 3.0 | 10 | 14 | 19 | 25 |

In a preferred embodiment, the difference in the crystallisation temperatures of polymer P1 and polymer P2 is <37° C., these crystallisation temperatures being measured as onset temperatures by DSC at a cooling rate of 20° C./min. In a preferred embodiment, this difference in the crystallisation temperatures is <30, preferably <20, more preferably <15, most preferably <10° C. Also, the crystallisation temperature of P1 is preferably greater than the crystallisation temperature of P2.

This condition ensures that P1 and P2 crystallise together at least in part, and these two components in the mixture of P1 and P2 melt together at least in part. In a preferred embodiment, the two components crystallise simultaneously and melt simultaneously. This can be achieved while keeping to the specified narrower limits even if the components have different crystallisation temperatures and melting points; cf. Table 3.

If polymer P1 and polymer P2 are present in a homogeneous mixture, then after cooling in DSC at 20° C./min, in subsequent heating at 20° C./min a melting peak is observed, differing from the melting peak of polymer P2 in terms of peak and/or onset temperature by <7, preferably <5, more preferably <3, most preferably <2° C.

If polymer P1 and polymer P2 are present in a homogeneous mixture, then after heating in DSC at 20° C./min, in subsequent heating at 20° C./min a crystallisation peak is observed, differing from the crystallisation peak of polymer P2 in terms of peak and/or onset temperature by <7, preferably <5, more preferably <3, most preferably <2° C.

TABLE 3

| | Propor- | Melting | | Crystallisation | | |
|---|---|---|---|---|---|---|
| | tion | Tm onset | Tm peak | Tc onset | Tc peak | MFI/ |
| P1, P2 | %-wt. | ° C. | ° C. | ° C. | ° C. | MFIo |
| HDPE | 100 | 125 | 140 | 118 | 115 | 1.00 |
| PW 500 | 7 | 123 | 140 | 118 | 115 | 1.90 |
| PW 1000 | 7 | 124 | 139 | 118 | 114 | 1.88 |
| PW 3000 | 7 | 124 | 139 | 119 | 116 | 1.75 |
| PW 500 | 100 | 56 | 81 | 83 | 74 | |
| PW 1000 | 100 | 94 | 113 | 108 | 103 | |
| PW 3000 | 100 | 121 | 129 | 117 | 113 | |

HDPE: Injection moulding type with MFI of 9.4 g/10 min at 190° C. and 2.16 kg
PW: Polywax types from Baker Petrolight

Table 4 shows expedient combinations of polymer P1 and polymer P2. The term “wax” here refers to an appropriate short-chain polymer.

TABLE 4

| Polymer P1 | Polymer P2 |
|---|---|
| HDPE | PE wax |
| HMWPE | |
| UHMWPE | |
| LDPE | |
| LLDPE | |
| VLDPE | |
| PE-PP copolymer | PE wax or PE-PP copolymer wax |
| PE copolymers | PE wax or PE copolymer wax |
| Isotactic PP | Isotactic PP wax |
| Syndiotactic PP | Syndiotactic PP wax |
| Atactic PP | Atactic, syndiotactic or isotactic PP wax |
| PP-PE copolymers | Isotactic or syndiotactic PP wax or PE wax |
| PP copolymers | Isotactic or syndiotactic PP wax or |
| | copolymer wax |
| PVA | PVA wax |
| PVC | PVC wax |
| PC | PC wax |
| PA | PA wax |
| PU | PU wax |
| ABS | ABS, PS, acrylonitrile or butadiene wax |
| PS | PS wax |

### Advantages of the Product

The advantages resulting from mixing a proportion of short-chain polymer P2 into a synthesised polymer P1 result from the short-chain polymer reducing the viscosity of the polymer melt (reduced internal friction) on the one hand, and from a lubricating effect being produced on the surface (reduced external friction) on the other hand.

In a preferred embodiment, the MFI of the mixture of polymer P1 with 7% by weight of polymer P2 is increased by a factor of >1.1, preferably >1.2, more preferably >1.3, most preferably >1.5. The lower the MFI of polymer P1, the more pronounced the effect. An upper limit is a factor of 6, in particular of 5, most particularly of 4.5. For lower or higher contents of P1, linear interpolation or extrapolation is performed.

The improvement in the flow properties which can be achieved with the proportion of polymer P2 is only reflected to an insufficient degree by the increase in the MFI, because the MFI is measured at very low shear rates. At the high shear rates which occur in practice, the improved flowability is substantially more pronounced than the increase in MFI would suggest. An MFI increased by a factor of 1.5 for example can easily lead to a reduction of approximately 30% in the cycle time for injection moulding.

This enables a considerable increase in productivity in comparison with processing polymer P1 alone: higher throughput, lower process times, reduced cycle times. A further optimisation results from the reduction in or elimination of build-ups at dies. Energy savings also result, because energy input and chamber temperatures can be reduced considerably (by 10 to 40° C.). However, a melt temperature reduced by 10 to 40° C. also allows gentle processing. Thus, heat-sensitive polymers can be processed more gently or heat-sensitive additives such as stabilising agents can be added in smaller amounts, and this results in further savings because additives of this type are generally expensive.

Burn marks which may arise during injection moulding are reduced or eliminated. A further advantageous application is the incorporation of master batches, pigments and fillers. Master batches can be homogenised more easily, as can pigments, and this means that improved wetting characteristics are also observed. Fillers may for example be talc, minerals, fibres, carbon, wood, etc. and these fillers each increase the viscosity, and this is detrimental to the processability of the polymers enriched with fillers. The use of mixtures of polymers P1 and P2 makes simpler and more rapid processing possible, the improved wetting characteristics of the polymer melt also playing a role in this case. Moreover, larger filling amounts are possible and heat-sensitive fillers such as wood and natural fibres can also be processed.

Mixtures of polymer P1 and P2 may in principle be used advantageously for all plastics material processing processes, for example for injection moulding, blow moulding, rotomoulding, film blowing, calendering, compounding, in particular when manufacturing polymer blends and master batches and when extruding films and profiles, increased productivity and/or a reduction in energy expenditure being achieved in each case. However, the extent of the advantage is dependent on the process and the devices. With a proportion of 3% of the polymer P2, process acceleration of >3, preferably >5, more preferably 7, most preferably >10% in terms of throughput is generally achieved. A 10 to 30% increase in productivity is typical, better or worse results being achieved according to the individual case. The process acceleration is extremely good in the injection moulding stage, for which the process acceleration is typically in the range of 15 to 35%.

The final properties of the polymers are not adversely affected, but actually slightly improved. With relatively higher proportions of the polymer P2, the modulus of elasticity and the yield limit are improved as a result of the increased crystallinity, whilst the toughness actually increases slightly, because lower mass temperatures and better flow characteristics result in fewer frozen-in stresses and deformations.

In a preferred embodiment, the modulus of elasticity and/or the strength of the mixture of polymer P1 with 7% of polymer P2 are increased by a factor of >1.03, preferably >1.05, more preferably >1.07, most preferably >1.10. The lower the crystalline content of polymer P1, the more pronounced the effect. An upper limit is a factor of approximately 2, in particular 1.85, most particularly 1.7. For lower or higher contents of P1, linear interpolation or extrapolation is performed.

It is noted that even a small increase in the modulus of elasticity and/or the strength is of great significance. If this allows products to be made with reduced wall thicknesses and a reduced weight, this will result in very substantial savings on raw materials, even if the products can only be produced with 1% less weight, because the total tonnages of polymers produced are extremely large.

This also applies to the energy saving when processing the polymers, as savings in the region of 10% are typical and these are very large in absolute terms when multiplied by the tonnages produced.

### Process

To manufacture the polymer mixture P1 and P2, devices which are already used for the synthesis and working up of polymers are employed, typical outputs of >1, preferably >3, more preferably >7, most preferably >14 to/h being achieved.

In the following, various processes by which polymer P2 can be combined with polymer P1 will be described, it being possible to feed/add a polymer P1 into the process in at least one process step during or after synthesis or during the working up of synthesised polymer P1. In principle, the same options may be applied to add at least one further polymer P3, which is miscible with the polymer P1, into the process resulting in further modification possibilities for polymer P1.

In principle, the polymer P2 may:

1. be fed/added and homogeneously distributed straight away in the reactor where the synthesis of the polymer P1 takes place, or in at least one of the reactors where the synthesis takes place if a plurality of reactors are used (the polymer P2 is thus added to the reactor in a form and at a moment such that reactions of polymer P2 with the catalyst for polymer P1 do not take place or are negligible. Therefore, polymer P2 is preferably introduced into the reactor at the end of the synthesis, or in particle form at reaction temperatures below the melting point of the polymer P2, which applies for example in the case of syntheses of polymer P2 in which polymer P2 is obtained in a powdered form)
2. or be fed and homogeneously distributed in one of the intermediate steps after synthesis,
3. or be fed and homogenised with the polymer on a molecular level during the subsequent working up of the synthesised polymer P1, for example during plasticisation and homogenisation, i.e. during the post-reactor extrusion, said post-reactor extrusion preferably being performed immediately after the synthesis of polymer P1,
4. or be added in part in steps 1 to 3 in combination,
in a particulate form, or in a molten state, as a coherent melt or spray, the polymer P2 preferably being fed together with the additives which are normally required for the polymer P2. In this case, the dispersion of the additives is facilitated by the polymer P2.

The processes are dependent on the polymer and the state thereof after the synthesis. The basic processes may in particular cases be modified specifically into individual variants, whereas it is the basic elements of the process, which elements thus should not been seen as limitations, that are described here.

### Working Up of Particles

Many polymers, such as HDPE, LLDPE and PP, occur in the form of particles, powder or fine granulates when synthesised. Either these powders are plasticised immediately in an extruder or compounder, homogenised and pelleted, or intermediate steps are introduced in which for example monomers are removed and/or catalysts are deactivated.

The polymer P2 may:

1. be fed and homogeneously distributed in the reactor where the synthesis of the polymer P1 takes place, or in at least one of the reactors where the synthesis takes place if a plurality of reactors are used
2. or be fed and homogeneously distributed at the particle level in one of the intermediate steps after synthesis,
3. or be fed during the plasticisation and homogenisation and homogenised with the polymer on the molecular level by post-reactor extrusion, said post-reactor extrusion preferably being performed immediately after the synthesis of polymer P1, optionally after intermediate storage for monomers to be removed by degassing,
it also being possible to use combinations of these processes.

In the first two variants, the polymer P2 is preferably used with a particle size comparable to the particle size of the powder of polymer P1. Because stirring typically takes place in the reactor and in the intermediate steps, mixing in polymer P2 does not require any fundamental change to the process. The homogenisation of polymer P2 with P1 on a molecular level takes place subsequently during the plasticisation and homogenisation. The advantage of the first two variants is that the addition of polymer P2 is superfluous for the plasticisation and homogenisation. On the other hand, in some processes additives are added in the reactor or in one of the intermediate steps, and so this option can be combined with the addition of polymer P2. A powdered blend of polymer P2 may advantageously be used with additives.

In the third variant, the polymer P2 is:

A. added to the working-up extruder together with the polymer P1, at least in part, the remainder of polymer P2 optionally being added at least further into the process, i.e. at a later time, typically in particle form using a lateral extruder (a lateral extruder can be omitted if the particles are introduced into an opening of the extruder, and in this case the screws must be configured accordingly), which is optionally cooled (cooling is generally advantageous if polymer P2 is fed using a lateral extruder), or in a molten form using a pump.
B. added at least further into the process than P1, i.e. at least at a later time, typically using at least one lateral extruder or at least one pump.

The sub-variant of A in which the entire proportion of polymer P2 is fed into the working-up extruder together with the polymer P1 (in this case, as in all cases of addition at the extruder, it is advantageous to add at a constant rate; if polymers P1 and P2 are added together, in whole or in part, they are preferably added into the extruder in an at least partially mixed state) is particularly suitable for small proportions of P2 in the range of up to 5, preferably 4, most preferably 3% by weight, in particular for product lines in which additives are also fed to the extruder together with polymer P1. As the extrusion is virtually completely adiabatic, the plasticisation is achieved exclusively by mechanical energy input. With small proportions of P2, this has little effect on the plasticisation of P1, as has been demonstrated by tests on smaller adiabatic systems. If polymer P2 has a substantially lower melting point or melting range than polymer P1, it is possible with larger proportions of polymer P2 that a low-viscosity film of polymer P2 may form around the particles of polymer P1, and this could reduce the friction and the mechanical energy input and thus impede the plasticisation. However, since powders have a large surface area and are often porous, this problem only occurs with higher proportions of polymer P2. On the other hand, this undesired lubricant effect can be at least partially prevented if a polymer P2 with a melting point similar to or higher than that of polymer P1 is used.

With larger proportions of P2 and/or if P2 melts at a substantially lower temperature than P1, the subvariant of A is used in which a first part is together with polymer P1 and at least a further part is fed at least at a later time during the extrusion, the remainder or the complete amount preferably being fed at a later time. In this way, larger proportions of polymer P2 and lower-melting polymers P2 can be mixed in without adversely affecting the plasticisation.

The decision as to how polymer P2 is fed also depends on the facilities of the individual working-up line. Subvariant B is used for example if the additives are fed at a later time than polymer P1 in the working up of polymer P1, for example via a lateral extruder, or if the plasticisation of polymer P1 is the bottleneck in the working up.

A further subvariant involves polymer P1 being sprayed with polymer P2 before the post-reactor extrusion.

If the desired amount of polymer P2 is added to the polymer P2 and P2 is plasticised, then P1 and P2 can be homogenised without difficulty, because the existing extruder configurations are configured to homogenise polymer P2. Because of the proportion of polymer P2, this homogenisation is now facilitated, because the viscosity of the melts decreases as the degree of homogenisation of polymers P1 and P2 increases. Homogenisation of polymers P1 and P2 is possible for small proportions of P2 of up to about 2% even with a number of short, simple single-screw extruders with a limited mixing effect, whereas during the working up of plastics materials, longer extruders or two extruders connected one after the other are used and double-screw extruders with a substantial mixing effect are available.

In two-stage processes, which are used for example for bimodally distributed polymers and in which polymer P2 is plasticised in a first extruder and homogenised in a second extruder, polymer P2 can be fed at the first extruder, for example together with polymer P1, or during the first extrusion using a lateral extruder or a pump, or at the start of or during the second extrusion using a lateral extruder or a pump, or with a combination of these possibilities. The same principles apply here as were explained above for the single-stage process. Furthermore, the use of polymer P2 also creates the possibility of reducing two-stage working up lines to one stage, because the homogenisation is substantially facilitated, in particular with high proportions of polymer P2.

The reduced melt viscosity results in energy savings, a reduction in the melt temperature and in particular a reduction in temperature and pressure peaks which occur before the screen changer and before the die. This creates the possibility of operating with higher throughputs and thus reducing the working up costs. Tests on smaller adiabatically operated extruders have shown that increases in throughput in the region of 5% and more are possible with 3% of polymer P2.

The following working up systems are typically used in powder processes: non-closely-intermeshing, counter-rotating double-screw extruders with 5 to 12D and D of 200 to approximately 500 mm, screw speeds of 350 to 850 rpm, powers of 1,500 to 13,000 kW and throughputs of 4 to approximately 60 to/h, with a single-screw melt extruder or melt pump connected downstream, and closely intermeshing, co-rotating double screw extruders with 15 to 24D and D of 100 to approximately 400 mm, screw speeds of 200 to approximately 450 rpm, powers of 500 to approximately 15,000 kW and throughputs of 4 to approximately 75 to/h, optionally with a melt pump connected downstream.

### Process for the Working Up of Melts

Various polymers such as LDPE, LLDPE, PP, EVA or PS occur in the form of a melt when synthesised. The melt is then discharged

1. using a single-screw extruder with a mixing section
2. or using a double-screw extruder with kneading discs and shear elements,
an additional extrusion for the purpose of homogenisation optionally taking place in variant 1 (two-stage process), whereas all process steps in variant 2, including homogenisation, are performed with a single-screw extruder with Maillefer screw shape and approximately 24D and D of 300 to approximately 600 mm, screw speeds of 80 to approximately 160 rpm, powers of 800 to approximately 4,000 kW and throughputs of 4 to approximately 30 to/h or with a closely intermeshing, co-rotating double screw extruder with approximately 21 D and D of 170 to approximately 350 mm, screw speeds of 200 to 350 rpm, powers of 600 to approximately 3,200 kW and throughputs of 5 to approximately 35 to/h (single-stage process). Monomers are removed by degassing.

By comparison with the powder method, mixing in the polymer P2 is facilitated to the extent that the polymer P1 is already present in the form of a melt, i.e. no plasticisation takes place. The polymer P2 may in principle be fed at any time during the working up, which is preferably performed immediately after the synthesis, in one or more steps, in particular even before the extrusion or the melt pump, in particulate form for example using an extruder or lateral extruder or in molten form using a pump. Preferably, polymer P2 is fed together with the additives, and the installations already present for this purpose, such as lateral extruders and/or pumps, are used.

In variant 1, polymer P2 may for example be introduced into the single-screw extruder, preferably in one of the first regions, in particular before the mixing section. Furthermore, incorporating polymer P2 increases the mixing effect and allows a better-homogenised material to be obtained, in such a way that the second stage for the purpose of homogenisation may optionally be omitted. In principle, however, the polymer P2 may also be fed in the homogenisation extruder, again preferably in one of the first regions.

In variant 2, the polymer P2 is preferably fed in one of the first regions and allows an additionally improved homogenisation and a more gentle process at lower temperatures and pressures as well as an optimised process with an improved throughput.

If degassing is performed in one of the variants, there is the possibility of introducing polymer P2 after this degassing if polymer P2 is drawn off substantially by the vacuum used, but preferably a polymer P2 with a sufficiently low vapour pressure at the current mass temperature is used.

### Process for the Working Up of Solutions

Vented extruders with multiple venting are used to compound polymers which result from solution polymerisation in the form of solutions, such as PE or LLDPE, the drawing off of the solvent preferably being assisted by water (water stripping). This achieves throughput rates in the range of 1 to 20 to/h.

The polymer P2 can be mixed in before the solution is extruded and then be homogeneously distributed or be introduced together with the solution or in one of the subsequent regions of the extruder. In this case, it should be ensured when selecting the polymer that the vapour pressure at the current temperature is sufficiently low that the polymer P2 is not substantially drawn off together with the solvent during the intensive degassing. Appropriate polymers P2 are available. Nevertheless, it is advantageous in most cases to feed the polymer P2 after the final degassing stage, which is when the additives and master batches are also normally added. In the subsequent extrusion steps, low mass temperatures, low pressures and better homogenisation are again achieved, whilst the throughput cannot be so greatly increased by the polymer P2 because this is primarily determined by the concentration of the solution supplied to the extruder.

The working up extruders typically used are non-closely-intermeshing, counter-rotating double-screw extruders with up to 60D and D of 150 to approximately 500 mm, screw speeds of 60 to 200 rpm, powers of 250 to approximately 3,500 kW and throughputs in the range of 1 to approximately 20 to/h and closely intermeshing, co-rotating double screw extruders with up to 30D and D of 130 up to approximately 350 mm, screw speeds of approximately 150 to approximately 300 rpm, powers of 300 to approximately 2,500 kW and throughputs in the range of 1 to approximately 20 to/h.

### Powder in Powder

Polymers which occur in the form of a powder when synthesised do not require the working up step by post-reactor extrusion, and the corresponding polymers are used commercially in powder form, optionally agglomerated. “Powder” indicates a particle size of <2 mm; above this size, it is a granulate.

In this case, polymer P1 and polymer P2 can be worked up to form a homogeneous mixture, the two particle types being mixed homogeneously on the particle level. To allow homogeneous mixing of this type and avoid subsequent demixing, the apparent densities and particle sizes of the two polymers should preferably meet the following conditions:

The difference in the apparent densities of polymer P1 and polymer P2 is <50, preferably <30, more preferably <20, most preferably <10%.

The difference in the average particle sizes of polymer P1 and polymer P2 is <50, preferably <30, more preferably <20, most preferably <10%.

If the polymer product P1 and P2 is in a form of this type, then the homogenisation on the molecular level is performed later when processing the particulate polymer mixture, this process being considerably simpler than the homogenisation of polymers P1 and P2 in processing devices when they are present in granulate form, in which case typically only 1% to at most 2% of polymer P2 can be homogenised. When processing a powder-formed premix, even simple processing extruders such as for example single-screw extruders with a limited mixing effect, such as are frequently used, can homogenise proportions of polymer P2 of up to approximately 6% by weight, mixtures with proportions of polymer P2 of preferably <5, more preferably <4.5, most preferably <4% by weight being used.

If powders of polymer P1 are agglomerated, then the agglomeration is preferably performed together with polymer P2, and the condition of the apparent density of the two components can be ignored. Preferably, polymer P2 is used as an agglomerator in the molten state, at least in part, it being possible to homogenise proportions of polymer P2 greater by approximately 1% on simple processing extruders.

### Coated Particles

Polymers which occur in the form of a powder when synthesised or are present in the form of a granulate after the post-reactor extrusion do not require the working up step by post-reactor extrusion, the powder or granulate of polymer P1 being coated at least in part with polymer P2, for example in that polymer P2 is sprayed onto the powder or granulate in a liquid form or as a dispersion, for example in the fluid bed.

If the polymer product P1 and P2 is present in a form of this type, then the homogenisation on the molecular level is performed later, during the processing of the particulate polymer mixture, this process also being considerably simpler than the homogenisation of polymer P1 and P2 on processing devices when they are present separately in granulate form, it typically only being possible to homogenise 1 to at most 2% of polymer P2. When processing partially coated granulate, even simple processing extruders such as single-screw extruders with a limited mixing effect, such as are often used, can homogenise proportions of polymer P2 of up to approximately 4.5% by weight, mixtures with proportions of polymer P2 of preferably <4.0, more preferably <3.7, most preferably <3.5% by weight being used.

If powders are coated, then proportions of polymer P2 comparable to those in the agglomeration of powder of polymer P1 are feasible.

### Advantages of the Process

By comparison with the plastics materials processors mixing polymer P2 in during processing, mixing the short-chained polymer P2 into synthesised polymers during the working up thereof means that on the one hand, there are economic advantages for logistical reasons and as a result of the low prices of polymers P2, resulting from the enormous tonnages required. On the other hand, the potential of short-chain polymers can only be realised optimally and completely in this way, because average processing devices can only sufficiently homogenise relatively small proportions of polymers of this type.

Furthermore, for the plastics materials manufacturers, who are moreover often capable of manufacturing the necessary polymers P2 themselves, incorporating polymer P2 into a synthesised polymer P1 involves small additional costs at most, because the existing working up processes can be used for this purpose and in most cases only the metering systems need be adapted. Furthermore, the advantages of polymers P2 may already be exploited in the working up of synthesised polymers P1, because the working up process, in particular the extrusion process, can be improved in terms of the throughput and moreover be performed more gently. In addition, a series of different modifications of polymer P2 can be obtained from a synthesised polymer P1 by adding various proportions of polymer P2 and by using various types of polymers P2, without syntheses having to be altered.

Overall, the post-reactor extrusion of polymers with the addition of a proportion of short-chain polymer results in energy savings in the range of a few percent. When the product is used in plastics materials processing, energy savings in the region of approximately 10% are achieved and by virtue of improved mechanical properties, material savings in the region of a few percent are possible. Because polymers are used in extremely large tonnages, these savings are of relatively great consequence in absolute terms, and productivity can also be increased considerably in plastics materials processing.

### EXAMPLES

For economic reasons, the examples were carried out on a small but realistic system. The results can be transferred to large systems using known construction methods.

A polymer in granulate form was used as polymer P1 in each case. As regards the potentially hindered plasticisation in the presence of polymer P2, granulate is more problematic that powder, and therefore positive tests on granulate imply positive results for powder. The tests were performed with a co-rotating, closely intermeshing double-screw extruder with L/D=24 and D=62 mm with 6 chambers at 4L/D. In the first region, the granulate was added a constant rate. In the second part of the second region and in the third region, the screw was configured over a length of 5L/D with kneading blocks followed by a return-conveying element as a plasticisation portion. In the fourth region, the extruder had an opening where polymer P2 could optionally be added, and in this region the screw was provided with conveying elements with an inclination of 1.5D. From the centre of the fifth region up to a point before the centre of the sixth region, the screw was configured as a homogenisation region for a length of 3 L/D with neutral kneading blocks with a 90° inclination, finishing off with a rearward-conveying kneading block. For the extraction, the pressure build-up was generated with conveying elements with an inclination of 1D. For the die, a strand die with 17 holes at 5 mm was used. The strands were granulated using a conventional strand granulation system with a water bath.

For polymer P1, an HDPE injection moulding with an MFI of 9.4 g/10 min in granulate form was used and the temperatures of the chambers and the die were set to 180/220/220/200/200/195/205° C., the screw speed was set to 300 rpm and the solid metering was set to a constant rate of 300 kg/h. Polywax 3000, Polywax 1000 and Polywax 500, which result in a wide range of advantageous polymers P2 in a homologous sequence, were used one after another for polymer P2 in a proportion of 3, 5 and 7% by weight respectively; these short-chain polymers are detailed in Table 1. Polymer P2 was initially added via the opening in the fourth region and test series 1 was thus produced. The mass temperature before the die of 218° C. in the control without polymer P2 was reduced to approximately 212/211/209° C. with 3% of polymer P2, to approximately 207/205/204° C. with 5% of polymer P2 and to 203/201/200° C. with 7% of polymer P2 for Polywax 3000/1000/500.

Subsequently, polymer P2 was added together with polymer P1 to analyse the effect of polymer P2 on the plasticisation of polymer P1; after a starting-up period of 15 min, heating and cooling were switched off to produce adiabatic conditions, i.e. to simulate mass production systems as realistically as possible. Test series 2 was produced in this state. It was found that at 3% of polymer P2 no plasticisation difficulties occurred, a macroscopic homogeneous mass could be seen in region 4, where the melt could be observed through the opening, and no unmelted particles of polymer P1 were observed. However, at 5% of polymer P2, some unmelted particles were found with Polywax 500, but even in this case a homogeneous melt was obtained at the die. At 7%, it was only with Polywax 3000 that no unmelted particles were obtained, but in all cases a homogeneous melt was obtained at the die.

The products were injected into various moulded parts on various injection moulding machines and the cycle times and material properties of the moulded parts were analysed. The reductions in the cycle times in comparison with polymer P1 without the proportion of polymer P2 were the same for test series 1 within the range of dispersion as for test series 2 and were, for the average of the various moulded parts, approximately 26% with a proportion of polymer P2 of 3%, approximately 34% with a proportion of 5% and approximately 37% with a proportion of 7%, it being possible to establish a significant increase in the cycle reduction with the decrease in molecular weight from Polywax 3000 to Polywax 500. The reduction in the cycle times resulted from the combination of faster plasticisation, faster injection, a shorter hold pressure time and faster ejection after injection, i.e. a shorter cooling time resulting from melt temperatures being greatly reduced by up to 40° C. Moreover, parts with more difficult shapes could be injected considerably better; parts which could not be injected with polymer P2 alone presented no difficulties with the polymer mixture P1 and P2. However, it was found that, in some cases even with a 3% proportion of polymer P2, some injection moulding machines reached technical limits and were no longer fast enough to exploit fully the potential of the improved flow properties; in particular, they could no longer be reloaded fast enough, and thus devices conditionally had holding times. At 7% of polymer P2, all of the machines were overstrained by the extremely easily injectable material. To exploit the full potential further, improved injection moulding machines are required, thus making even higher cycle time reductions possible.

In the range of dispersion for 3% of polymer P1, the properties of the moulded parts were unaffected or better (increased modulus of elasticity due to increased crystallinity and better toughness due to reduced frozen-in stresses) as compared with the control without polymer P2; the same applies for 5% of polymer P2, except for Polywax 500 where a reduction of approximately 5% in the toughness was found. At 7% of polymer P2, the properties for Polywax 3000 were unaffected or better as compared with the control, whilst a reduction in the toughness of approximately 5% for Polywax 1000 and approximately 10% for Polywax 500 was found.

The tests thus show that with the proposed process for the working up of polymers after synthesis, it is possible to produce specific mixtures with short-chain polymers which have substantially improved flow characteristics which can be exploited to obtain considerable increases in productivity in plastics material processing. When using polymers P2 with a lower melting point than polymer P1, difficulties in the plasticisation of polymer P2 are possible at more than 3%; however, the advantageous proportions of polymers P2 of this type with a generally very low viscosity are as a rule not much more than 3%, or if so, then split feeding can be used for the homogenisation with polymer P1, polymer P1 being fed after the plasticisation of polymer P2.

To analyse mixtures of polymer P1 and P2 where they are used premixed in powdered form, the HDPE injection moulding of the above test series was comminuted to form a powder with an average particle size of 1 mm and mixed with a Polywax 1000 powder of the same average particle size in a tumble mixer, the densities and apparent densities of the two polymers differing by 3 to 8%. The proportions of polymer P2 were 3, 5 and 7%.

Subsequently, these powder mixtures were extruded with a single-screw extruder, which is a typical single-screw processing extruder with limited mixing effect. The products obtained were analysed by DSC to find out whether homogenisation took at the molecular level in the region of 113° C., at which Polywax 1000 melts if it does not melt with the HDPE, which melts at 140° C. With up to 5% Polywax 1000, no separate melting peak of this type could be observed, and thus complete homogeneity was obtained in the extrusion. At 7% Polywax 1000, by contrast, a separate melting peak was found, corresponding to approximately 1% non-homogenised Polywax 1000. The DSC tests were each performed on 20 individual samples which were extracted at different times during the extrusion.

To analyse mixtures of polymers P1 and P2 where polymer P1 is coated with polymer P2 at least in part and is used in this form, the HDPE injection moulding of the above test series was used in granulate form with a granule size of approximately 4 to 5 mm. Batches with 3, 4 and 6% Polywax 1000 were produced in a Pappenmeier mixer, liquid Polywax being sprayed into the mixer. Subsequently, these mixtures were extruded with the same single-screw extruder as in the powder tests and the products were analysed by DSC for the presence of a separate phase with a melting point of 113° C. The mixtures with 3 and 4% Polywax 1000 were completely homogeneous, whilst at 6% Polywax 1000 a separate melting peak was found, corresponding to approximately 1.5% non-homogenised Polywax 1000. In this case, too, the DSC tests were each performed on 20 individual samples which were extracted at different times during the extrusion.

1. Process for the production of a polymer mixture M, wherein the polymer mixture comprises a polymer P1 and a polymer P2, comprising the steps of
using as polymer P1 a polymer that has an average molecular weight Mn of >20,000 g/mol and at least one block of >10 monomers M1, and
using as polymer P2 a polymer that has a viscosity in the range of 0.1 to <3,000 mPas above the melting point and comprises at least one block of >10 monomers M2, wherein the monomers M1 and M2 are identical,
adding polymer P2 is to polymer P1 in a reactor,
the proportion of P2 in % by weight based on P1 and P2 is in the range of 0.1 to 25, and
using devices for the synthesis and working up of synthesized polymers for the process with an output for each production line being >1 to/h.

2. Process according to claim 1, wherein the polymer P2 is added to the polymer P1 at least in the reactor where the synthesis of the polymer P1 takes place.

3. Process according to claim 1, wherein the polymer P2 is mixed homogeneously on the molecular level in the melt phase in a working up step of the synthesized polymer P1.

4. Process according to claim 3, wherein the homogenization of the synthesized polymer P1 and P2 is performed using an apparatus selected from the group consisting of extruders, kneaders, internal mixers, melt pumps, and a static mixer or a combination thereof.

5. Process according to claim 3, wherein the synthesized polymer P1 is obtained in form of particles and the homogenization of polymer P1 and P2 takes place during the subsequent plasticization of polymer P1 during the post-reactor extrusion.

6. Process according to claim 5, wherein the polymer P2 is mixed in during the post-reactor extrusion at least in part before the plasticization of the synthesized polymer P1.

7. Process according to claim 1, wherein the synthesized polymer P1 is obtained in form of particles and is sprayed with the polymer P2 before the post-reactor extrusion.

8. Process according to claim 3, wherein the synthesized polymer P1 is obtained in form of a melt and the polymer P2 is mixed into the melt during the post-reactor extrusion and is subsequently homogenized.

9. Process according to claim 3, wherein the synthesized polymer P1 is obtained in form of a solution and the polymer P2 is mixed into this solution at a time before, during or after the concentration of this solution by post-reactor extrusion and is subsequently homogenized.

10. Process according to claim 1, wherein the synthesized polymer is obtained in form of powder and the polymer P2 is mixed with this powder homogeneously on the particle level.

11. Process according to claim 1, wherein the synthesized polymer P1 is obtained in a form selected from the group consisting of particles, powder and granulate, and these are coated at least in part with the polymer P2.

12. Process according to claim 1, wherein the polymer P2 is added together with at least one additive for the synthesized polymer P1 in the polymer.

13. Process according to claim 1, wherein the difference in the crystallisation temperatures of polymer P1 and polymer P2 is <37° C., the crystallisation temperatures being measured as onset temperatures by DSC with a cooling rate of 20° C./min.

14. Process according to claim 1, wherein the average molecular weight Mw of P1 is >20,000 g/mol.

15. Process according to claim 1, wherein P1 is selected from the group consisting of: polyolefins, PE, PP, PE-PP copolymers, PE-copolymers, PP-PE copolymers, PP copolymers, PVA, PVC, PC, PA, PU, ABS, PS, SAN, POM, CA, PMMA, PPE, PPS, PSO, PTFE, PET, and PBT.

16. Process according to claim 1, wherein the polymer P1 is a polyolefin.

17. Process according to claim 1, wherein the polymer P1 has a crystalline content of >3% by weight.

18. Process according to claim 1, wherein the MFI of polymer P1 at standard temperature and 2.16 kg is in the range of 0.005-200 g/10 min.

19. Process according to claim 1, wherein the polydispersity of polymer P2 is <10.

20. Process according to claim 1, wherein polymer P2 is predominantly linear or spheroid.

21. Process according to claim 1, wherein the vapour pressure of polymer P2 at 250° C. is <100 mbar.

22. Process according to claim 1, wherein the polymer P2 is selected from the group consisting of short-chain or spheroid polymers: PE, PVA, PVC, PC, PA, PU, ABS, PS, SAN, POM, CA, PMMA, PPE, PPS, PSO, PTFE, PET, and PBT.

23. Process according to claim 1, characterised in that wherein the MFI of the mixture of polymer P1 with 7% by weight of polymer P2 is greater than the MFI of polymer P1 by a factor of >1.1 to 6.

24. Process according to claim 1, wherein the modulus of elasticity of the mixture of polymer P1 with 7% by weight of polymer P2 is greater than the modulus of elasticity of polymer P1 by a factor of 1.03 to 2.

25. Process according to claim 1, wherein the mixture of polymer P1 and P2 is in a particulate form.

26. Process of claim 1, wherein a further polymer P3 which is miscible with polymer P1 is added to polymer P1.

27. Process of claim 26, wherein polymer P3 is added at a location selected from the group consisting of the reactor where the synthesis of the polymer P1 takes place, in a plurality of reactors used for the synthesis of the polymer P1, in at least one of the reactors, in one of the intermediate steps after the synthesis of polymer P1, and is added during the working up of the synthesized polymer P1 before polymer P1 is fully worked up.

28. Process of claim 1, wherein polymer P2 is added at a location selected from the group consisting of the reactor where the synthesis of the polymer P1 takes place, in a plurality of reactors used for the synthesis of the polymer P1, in at least one of the reactors, in one of the intermediate steps after the synthesis of polymer P1, and is added during the working up of the synthesized polymer P1 before polymer P1 is fully worked up.
